(19) United States
(12) Patent Application Publication
(10) Pub. No.: US 2012/0133804 A1
(43) Pub. Date: May 31, 2012

(54) APPARATUS AND METHOD FOR CORRECTING DEFECTIVE PIXEL

(75) Inventor: Geon Pyo KIM, Gyeonggi-do (KR)

(73) Assignee: HYNIX SEMICONDUCTOR INC., Icheon-si (KR)

(21) Appl. No.: 13/294,337

(22) Filed: Nov. 11, 2011

(30) Foreign Application Priority Data
Nov. 12, 2010 (KR) 10-2010-0112779

(51) Int. Cl. H04N 9/64

(52) U.S. Cl. 348/246; 348/E09.042

(57) ABSTRACT

Provided is an apparatus and method for detecting and correcting a defective pixel with consideration of a position of the target pixel. The apparatus includes a target pixel area discrimination unit discriminating a position of a target pixel, a defective pixel determination unit selecting neighboring pixels in consideration of the position of the target pixel and determining whether or not the target pixel is defective, and defective pixel correction unit correcting the target pixel by using the neighboring pixels.

### CROSS-REFERENCE TO RELATED APPLICATIONS

This application claims the priority of Korean Patent Application No. 10-2010-0112779 filed on Nov. 12, 2010 in the Korean Intellectual Property Office, the disclosure of which is incorporated herein by reference in its entirety.

### BACKGROUND OF THE INVENTION

1. Field of the Invention

The present invention relates generally to imaging, and more specifically to an apparatus and method for correcting a defective pixel.

2. Description of the Related Art

Pixels operating abnormally in a complementary metal oxide semiconductor image sensor (CMOS Image Sensor or CIS) may be variously referred to as a defective pixel, a dead pixel, or a bad pixel. Defective pixels mainly occur due to defects in any of several elements configuring a pixel, such as, for example, a transistor or a diode.

In a case where a defective pixel outputs a pixel value, that is similar to that of a neighboring pixel, the error may be small. But when the pixel value of the defective pixel is greatly different from that of the neighboring pixel, image distortion may occur.

In addition, in the case where a pixel saturation level is represented in the middle of a value, instead of appearing in the form of a symmetry value in a reference sloop or a maximum pixel value, or is represented at upper and lower parts of the reference sloop, a defect in which a pixel is not clearly colored may be caused.

The above-mentioned defect is a concern for image distortion and, hence, may reduce production yield. That is, in the case of a CIS without a defective pixel compensation (DPC) function, production yield may be lowered compared to a CIS correcting a defective pixel using a DPC function. The DPC is emerging as an important CIS function for correcting defective pixels.

However, if a single scheme DPC is applied without distinguishing a position or directionality of a target pixel, an image distortion phenomenon may occur. Furthermore, since the function is limited to detecting and compensating for a single defective pixel, a cluster of dead pixels occurring in a shared pixel structure may not be effectively detected. Furthermore, when pixels other than a centralized pixel are defective, effective edge detection may be difficult and there may also be difficulties in correcting defective pixels to be appropriate to image characteristics.

In the case of a single DPC without consideration of image characteristics, in a position of a target pixel, it is determined whether the target pixel is a defective pixel by analyzing differences between a target pixel P33 and a plurality of homogeneous pixels P11, P13, P15, P31, P35, P51, P53 and P55 near the target pixel P33 as shown in FIGS. 1A and 1B. Homogeneous pixels may be those pixels that provide information about the same color.

In this case, when the target pixel is located on a flat area, or a low frequency area, since the eight homogeneous pixels can be absolutely compared, there may be no difficulties in detecting and compensating for a defective pixel.

However, in a case in which a target pixel is positioned on an edge area, or a high frequency area, it is determined whether the target pixel is a defective pixel by using differences between the target pixel P33 and the eight neighboring homogeneous pixels P11, P13, P15, P31, P35, P51, P53 and P55 as shown in FIG. 1B. In this case, it is difficult to precisely discern a difference between a defective pixel that is subdivided into a white pixel, a black pixel, a hot pixel or a cold pixel, and an edge having directionality, to precisely detect the defective pixel through difference values having relatively large variations.

In addition, in a correction scheme, when an arithmetic operation is performed by selecting neighboring pixels matched to an image characteristic, natural image characteristics can be obtained, but when the correction scheme used on the flat area is applied to an edge area as it is, image characteristics may be blurred, causing image distortion. The following mathematical expression 1 represents a correction expression based on the correction scheme used on the flat area.

$$[ Mathematical Expression 1 ]$$

$$\frac{( P 11 + P 13 + P 15 + P 31 + P 35 + P 51 + P 53 + P 55 )}{8}$$

Furthermore, as shown in FIGS. 2A and 2B, when an additional defective pixel is present among the pixels homogeneous with a target pixel, a single defective pixel detection scheme cannot be used to determine whether the target pixel is defective. Accordingly, another defective pixel P13 present within a 5×5 grid may affect an arithmetic operation required to discern the target pixel.

Furthermore, in a method of correcting a defective pixel, even when the pixel is a defective pixel existing in the flat area, since a correction value may be influenced by the additional defective pixel P13 within the 5×5 grid, an error may occur. In this case, as examples of errors, the defective pixel is compensated as a hot pixel as compared to a pixel on the periphery in the case of a white pixel, or the defective pixel is compensated as a cold pixel as compared to a pixel on the periphery in the case of a block pixel, instead of an operation in which a correction value of the target pixel is substituted with a value matched to the neighbor of the target pixel.

### SUMMARY OF THE INVENTION

An aspect of the present invention provides an apparatus and method for detecting and correcting a defective pixel in consideration of a position of a target pixel.

Another aspect of the present invention provides an apparatus and method for correcting a defective pixel that is capable of considering the number of defective pixels as well as a position of a target pixel.

According to an aspect of the present invention, there is provided an apparatus for correcting a defective pixel, the apparatus including: a target pixel area discrimination unit configured to discriminate a position of a target pixel; a defective pixel determination unit configured to select neighboring pixels in consideration of the position of the target pixel to determine whether the target pixel is defective; and a defective pixel correction unit configured to correct the target pixel by using at least some of the neighboring pixels.

According to another aspect of the present invention, there is provided a method of correcting a defective pixel, the method including: determining a position of a target pixel by using neighboring pixels of the target pixel, wherein each of the neighboring pixels is a homogeneous pixel with respect to the target pixel and is separated from the target pixel by a single pixel vertically, horizontally, or diagonally; selecting a subset of the neighboring pixels in consideration of the position of the target pixel; determining whether the target pixel is defective by using the subset of the neighboring pixels; and correcting the target pixel using the subset of the neighboring pixels if the target pixel is determined to be defective.

According to another aspect of the present invention, there is provided a method of correcting a defective pixel, the method including: determining a position of a target pixel by using neighboring pixels of the target pixel, wherein each of the neighboring pixels is separated from the target pixel by a single pixel vertically, horizontally, or diagonally; determining whether the target pixel is a single defective pixel or one of a plurality of defective pixels; and correcting the target pixel, when the target pixel is the single defective pixel, by using the neighboring pixels in a first manner, and when the target pixel is one the plurality of defective pixels is present, correcting the target pixel by using the neighboring pixels in a second manner.

### BRIEF DESCRIPTION OF THE DRAWINGS

The above and other aspects, features and other advantages of the present invention will be more clearly understood from the following description taken in conjunction with the accompanying drawings:

FIGS. 1A and 1B are drawings showing a defective pixel detection principle according to related art;

FIGS. 2A and 2B are drawings showing a case in which a cluster of defective pixels is present;

FIG. 3 is a drawing showing an apparatus for correcting a defective pixel according to an embodiment of the present invention;

FIGS. 4A to 4C are drawings showing the principle of discriminating a position of a target pixel in a target pixel area discrimination unit according to an embodiment of the present invention;

FIGS. 5A to 5C are drawings showing the principle of determining whether a target pixel is defective in a defective pixel determination unit according to an embodiment of the present invention;

FIG. 6 is a flowchart showing a method of correcting a defective pixel according to an embodiment of the present invention;

FIG. 7 is a block diagram of an apparatus for correcting a defective pixel according to another embodiment of the invention;

FIGS. 8A to 8C are drawings showing the principle of discriminating a position of a target pixel in a target pixel area primary discrimination portion and a target pixel area secondary discrimination portion according to an embodiment of the present invention;

FIGS. 9A to 9E are drawings showing the principle of determining a defective pixel in a defective pixel determination unit according to an embodiment of the present invention; and

FIG. 10 is a drawing showing a method of correcting a defective pixel according to another embodiment of the present invention.

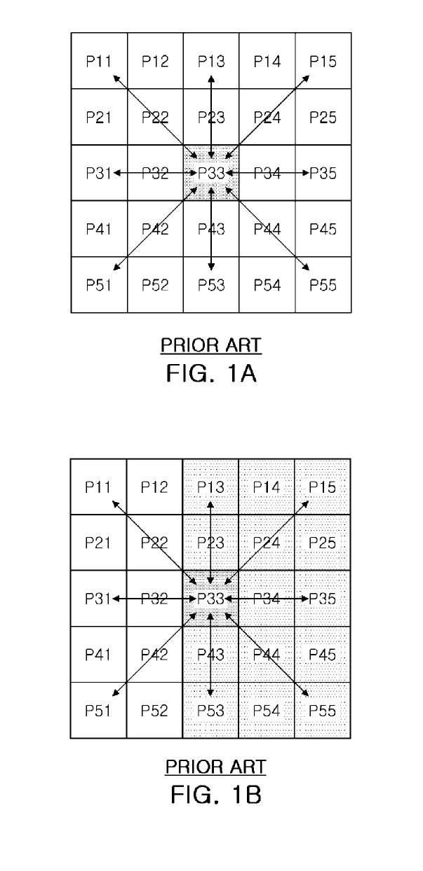

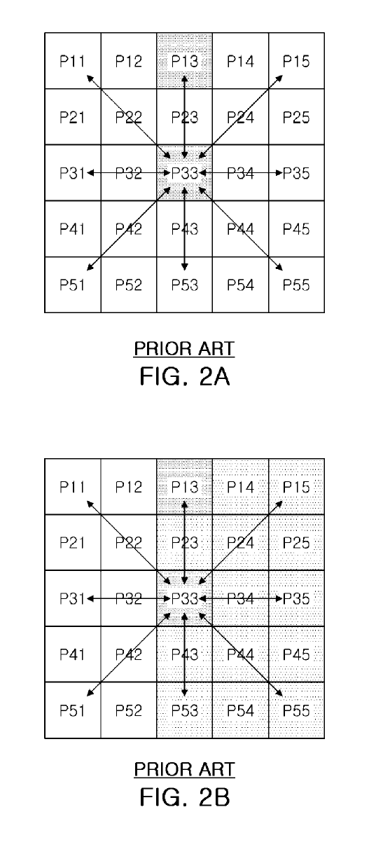

### DETAILED DESCRIPTION OF THE INVENTION

The present invention may be variably modified and implemented in various embodiments, particular examples of which will be illustrated in drawings and described below.

However, it should be understood that the following descriptions of the invention are not intended to restrict the invention to specific forms of the present invention but rather to describe the scope of the present invention to those skilled in the art.

The terms used in the present application, for example, a first, a second, or the like, are merely used to describe particular embodiments, and are not intended to limit the present invention. An expression used in the singular encompasses the expression of the plural, unless it has a clearly different meaning in the context in which it is used. In the present application, it is to be understood that terms such as “including” or “having,” etc., are intended to indicate the existence of features, numbers, operations, actions, components, parts, or combinations disclosed in the specification, and are not intended to preclude the possibility that one or more other feature, number, operation, action, component, part, or combination may exist or may be added.

Unless otherwise defined, all terms used herein, including technical or scientific terms, have the same meanings as those generally understood by those with ordinary knowledge in the field of art to which the present invention belongs. Such terms as those defined in a generally used dictionary, which may be art specific, are to be interpreted as having meanings equal to the contextual meanings in the relevant field of art, and are not to be interpreted as having ideal or excessively formal meanings unless clearly defined as having such in the present application.

Embodiments of the present invention will be described below in detail with reference to the accompanying drawings, where those components that are the same or are in correspondence are referred to by using the same reference number, regardless of the figure number, and redundant explanations are omitted.

Hereinafter, for convenience of explanation, detecting and correcting a single defective pixel included in Bayer row data will be described using a 5×5 grid. However, it should be understood that the invention is not limited to using 5×5 grids. Various embodiments of the invention may use other grid sizes, including a grid size of M×N where M is different from N. Similarly, while a 3×3 grid is used below, an embodiment of the invention need not be limited to that size grid.

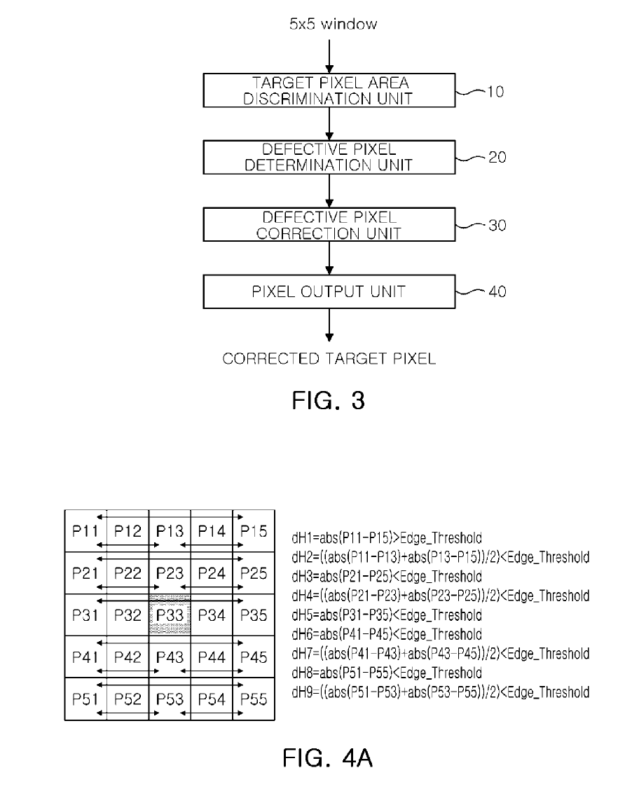

FIG. 3 is a drawing showing an apparatus for correcting a defective pixel according to an embodiment of the invention.

With reference to FIG. 3, the apparatus for correcting a defective pixel may include a target pixel area discrimination unit 10, a defective pixel determination unit 20, a defective pixel correction unit 30, and a pixel output unit 40. The target pixel area discrimination unit 10 may discriminate with regard to an area in which a target pixel is located, for example, between a flat area, a horizontal edge area, and a vertical edge area. The defective pixel determination unit 20 may select neighboring pixels in consideration of a position of a target pixel and determine whether the target pixel is defective. The defective pixel correction unit 30 may correct the target pixel by using the neighboring pixels, and the pixel output unit 40 may provide a corrected target pixel value as an output.

Functions of the respective elements described above will be described in more detail below.

The target pixel area discrimination unit 10 may divide an area having a target pixel located therein into a flat area, a horizontal edge area, and a vertical edge area by using, for example, a 5×5 grid centered about the target pixel.

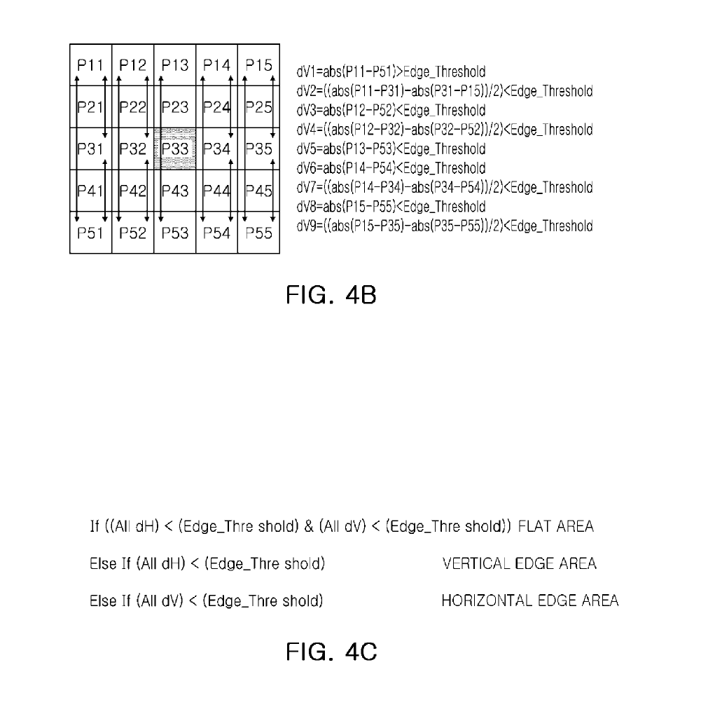

To this end, the target pixel area discrimination unit 10 may compare pixel values between a plurality of pixels on a row and column basis to acquire row-based pixel value differences dH1 to dH9 and column-based pixel value differences dV1 to dV9 as shown in FIGS. 4A and 4B.

[Mathematical Expression 2]

dH1=abs(P11−P15)
dH2=((abs(P11−P13)+abs(P13−P15))/2)
dH3=abs(P21−P25)
dH4=((abs(P21−P23)+abs(P23−P25))/2)
dH5=abs(P31−P35)
dH6=abs(P41−P45)
dH7=((abs(P41−P43)+abs(P43−P45))/2)
dH8=abs(P51−P55)
dH9=((abs(P51−P53)+abs(P53−P55))/2)

[Numerical Expression 3]

dV1=abs(P11−P51)
dV2=((abs(P11−P31)+abs(P31−P51))/2)
dV3=abs(P12−P52)
dV2=((abs(P12−P32)+abs(P32−P52))/2)
dV5=abs(P13−P53)
dV6=abs(P14−P54)
dV2=((abs(P14−P34)+abs(P34−P54))/2)
dV8=abs(P15−P55)
dV2=((abs(P15−P35)+abs(P35−P55))/2)

Thereafter, as shown in FIG. 4C, the row-based pixel value difference (All dH=dH1˜dH9) and the column-based pixel value difference (All dV=dV1˜dV9) may be compared with an edge detection reference value Edge_Threshold. As a result, when the value of all pixel value differences is less than the edge detection reference value Edge_Threshold, a position of the target pixel P33 may be defined as a flat area (P33=Flat). When the value of all row-based pixel value differences (All dH=dH1˜dH9) is less than the edge detection reference value Edge_Threshold, a position of the target pixel P33 may be defined as the vertical edge area (P33=Vertical_Edge). When the value of all column-based pixel value differences (All dV=dV1˜dV9) is less than the edge detection reference value Edge_Threshold, a position of the target pixel P33 may be defined as the horizontal edge area (P33=Horizontal_Edge).

The defective pixel determination unit 20 may select different neighboring pixels to be used for a detection of a defective pixel according to a position of the target pixel. That is, neighboring pixels are selected in consideration of the position of the target pixel, and it is confirmed whether a pixel value difference between the neighboring pixels and the target pixel deviates from a defective pixel detection range, that is, High_Threshold(%)˜Low_Threshold(%), thereby verifying whether the target pixel is defective.

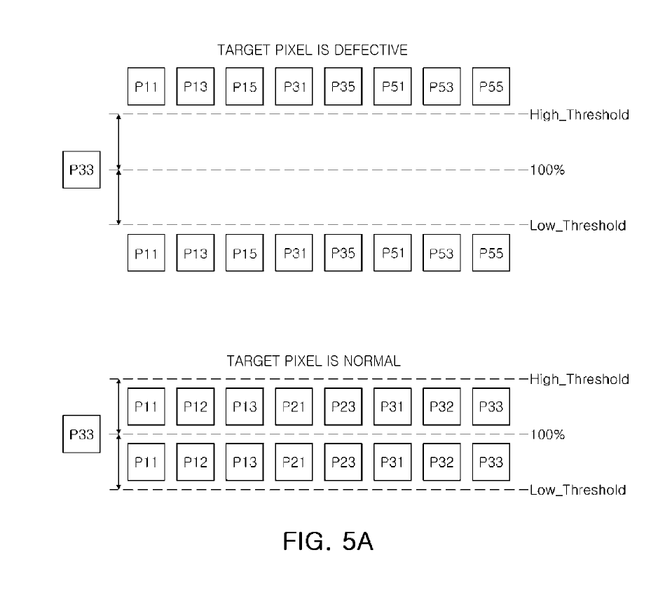

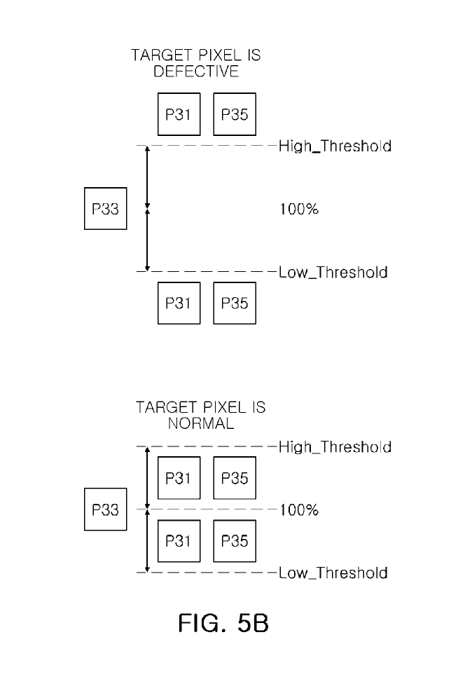

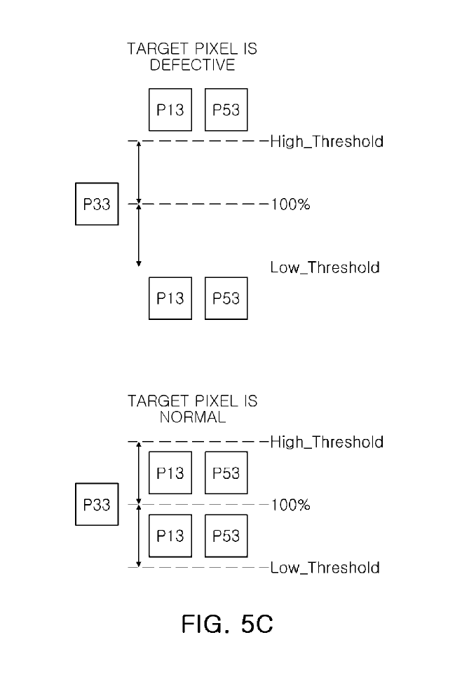

To this end, when the position of the target pixel P33 is in a flat area, the defective pixel determination unit 20 may select all pixels homogeneous with the target pixel P33, that is, pixels spaced one apart from the target pixel in horizontal, vertical, and diagonal directions, which are, for example, P11, P13, P15, P31, P35, P51, P53 and P55, as shown in FIGS. 4A, 4B, and 5A. When the position of the target pixel P33 is a horizontal edge area, only homogeneous pixels P31 and P35 located to the right and left of the target pixel may be selected as neighboring pixels, as shown in FIGS. 4A, 4B, and 5B. Similarly, when the target pixel is located on a vertical edge area, only homogeneous pixels P13 and P53 located above and below the target pixel may be selected as neighboring pixels as shown in FIGS. 4A, 4B, and 5C.

In addition, when pixel value differences between the selection-completed neighboring pixels ((P11, P13, P15, P31, P35, P51, P53, P55), (P31, P35), or (P13, P53)) and the target pixel are obtained, and all obtained pixel value differences are within the defective pixel detection range, High_Threshold(%)˜Low_Threshold(%), the target pixel may be determined as a normal pixel. When all of the obtained pixel value differences deviate from the defective pixel detection range, High_Threshold(%)˜Low_Threshold(%), the target pixel may be determined as a defective pixel.

The defective pixel correction unit 30 may also select different neighboring pixels to be used for correction of the target pixel according to a position of the target pixel. That is, when the position of the target pixel is the flat area, the target pixel P33 may be corrected by using all homogeneous pixels P11, P13, P15, P31, P35, P51, P53 and P55 (Mathematical Expression 4), but when the position of the target pixel is the horizontal edge area, the target pixel P33 may be corrected using only homogeneous pixels P31 and P35 located on the right and left of the target pixel P33 (Mathematical Expression 5). Further, when the target pixel is located on a vertical edge area, the target pixel P33 may be corrected by only using homogeneous pixels P13 and P53 located above and below the target pixel P33 (Mathematical Expression 6).

$$\begin{matrix}\frac{( \begin{matrix}P 11 + P 13 + P 15 + P 31 + \\ P 35 + P 51 + P 53 + P 55\end{matrix} )}{8} & [ Mathematical Expression 4 ] \\ \frac{( P 31 + P 35 )}{2} & [ Mathematical Expression 5 ] \\ \frac{( P 13 + P 53 )}{2} & [ Mathematical Expression 6 ]\end{matrix}$$

The pixel output unit 40 may clamp and output a corrected pixel value of the target pixel in order to prevent an over-flow in the correction results.

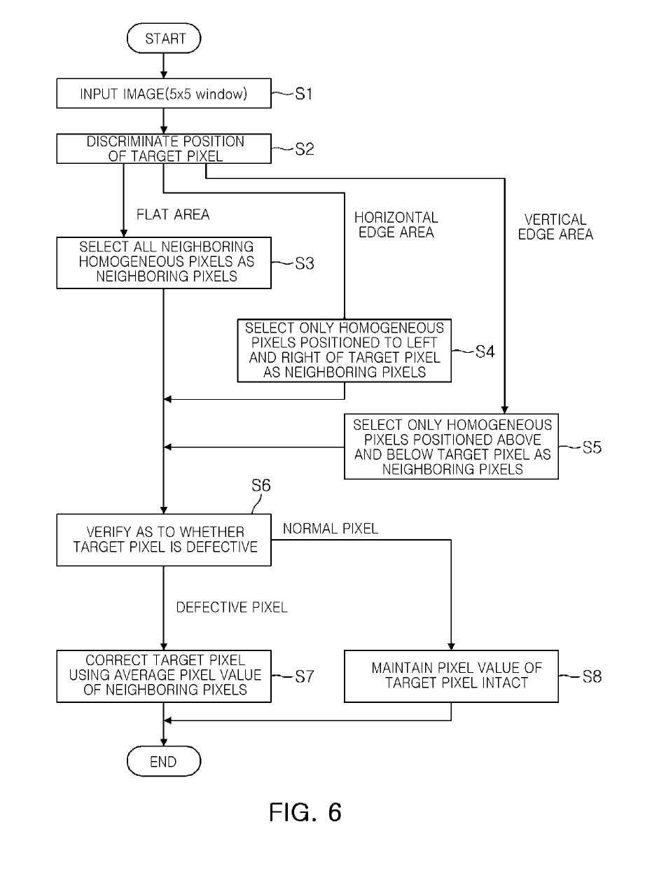

FIG. 6 is a flowchart showing a method of correcting a defective pixel according to an embodiment of the invention. First, when a 5×5 grid-based image is input in operation S1, pixel values in a plurality of pixels may be analyzed on a row and column basis to acquire row-based pixel value differences dH1˜dH9 and column-based pixel value differences dV1˜dV9. A position of the target pixel P33 may be discriminated in operation S2 by comparing with the edge detection reference value Edge_Threshold.

For example, when the target pixel P33 is located on the flat area, all homogeneous pixels P11, P13, P15, P31, P35, P51, P53 and P55 may be selected as neighboring pixels in operation S3.

When the target pixel is located on the horizontal edge area, the homogeneous pixels P31 and P35 positioned to the left and right of the target pixel may be selected as neighboring pixels in operation S4. When the target pixel P33 is located on a vertical edge area, the homogeneous pixels P13 and P53 positioned above and below the target pixel P33 may be selected as neighboring pixels in operation S5.

Pixel value differences between the neighboring pixels (P11, P13, P15, P31, P35, P51, P53, P55), (P31, P35), or (P13, P53) selected by operation S3, S4 or S5 and the target pixel may be obtained and then compared with defective pixel detection ranges High_Threshold(%) Low_Threshold(%) to verify whether the target pixel is defective in operation S6.

As a result of operation S6, when all pixel value differences deviate from the defective pixel detection ranges High_Threshold(%)˜Low_Threshold(%), the target pixel is determined as a defective pixel and the target pixel may be corrected according to the above-mentioned mathematical expression 4 in operation S7.

When all the pixel value differences are included in the defective pixel detection ranges High_Threshold(%)˜Low_Threshold(%) such that the target pixel is determined as a normal pixel, the target pixel is not corrected but a pixel value of the target pixel may be maintained intact in operation S8.

As described above, according to an embodiment of the present invention, the target pixel may be discriminated with regard to its position and the processes for selecting the neighboring pixels and correcting the target pixel may depend on the position of the target pixel.

As previously described, one or more of the homogeneous pixels rather than a target pixel within the 5×5 grid may be defective. Accordingly, according to an embodiment of the present invention, an additional apparatus capable of performing a precise and reliable defective pixel correction operation may be provided.

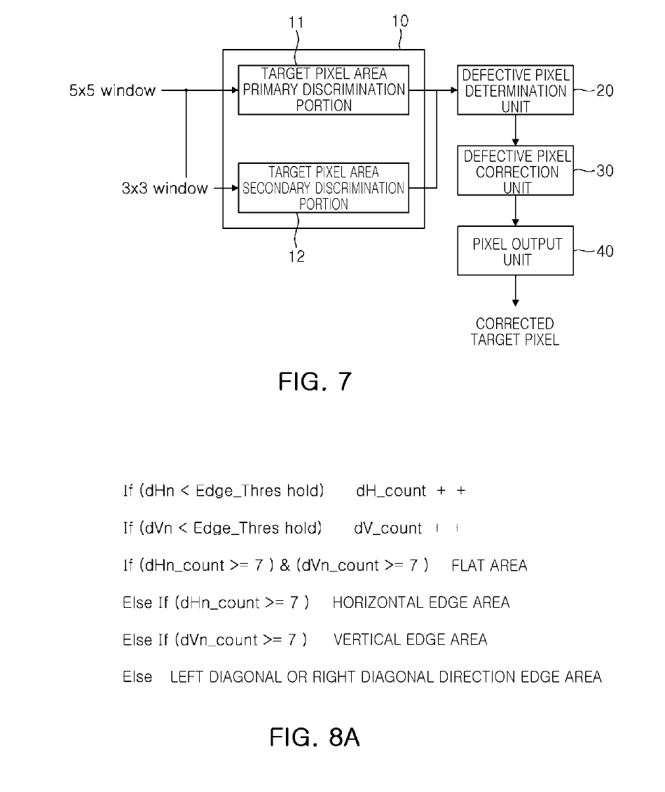

FIG. 7 is a block diagram of an apparatus for correcting a defective pixel according to another embodiment of the invention.

With reference to FIG. 7, the apparatus for correcting a defective pixel may include the target pixel area discrimination unit 10 including a target pixel area primary discrimination portion 11 and a target pixel area secondary discrimination portion 12.

The target pixel area primary discrimination portion 11 may subdivide a position of a target pixel into a flat area, a vertical edge area, or a horizontal edge area to discriminate by a 5×5 grid.

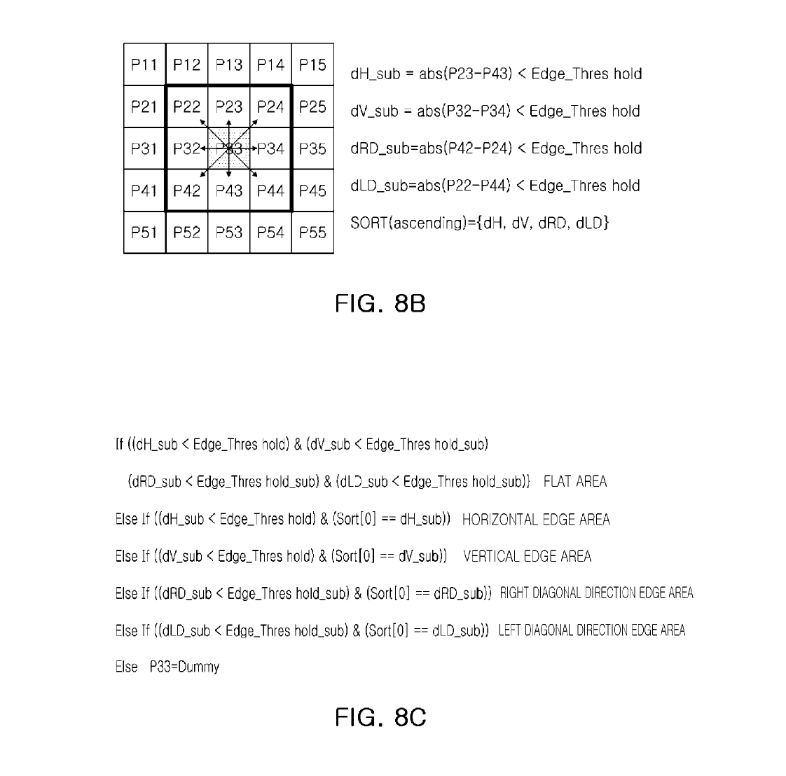

However, even in a case in which a portion of the row-based pixel value differences dH1˜dH9 or the column-based pixel value differences dV1˜dV9 has a value greater than the edge detection reference value Edge_Threshold, the target pixel area primary discrimination portion 11 may discriminate the positions of the target pixel as shown in FIG. 8A. That is, when a portion, for example, seven or more, in the row-based pixel value differences dH1˜dH9 or the column-based pixel value differences dV1˜dV9 have values lower than the edge detection reference value Edge_Threshold, the target pixel may be defined as being positioned in the flat area (P33=flat). Similarly, when a portion, for example, seven or more, in the row-based pixel value differences dH1˜dH9 have values lower than the edge detection reference value Edge_Threshold, the horizontal edge area may be defined as a position of the target pixel, and when a portion, for example, seven or more, in the column-based pixel value differences dV1˜dV9 have values lower than the edge detection reference value Edge_Threshold, the vertical edge area may be defined as a position of the target pixel.

The target pixel area secondary discrimination portion 12 may subdivide a positional area of a target pixel into a flat area, a horizontal edge area, a left diagonal direction edge area, and a right diagonal direction edge area to discriminate by using 9 elements configuring a 3×3 grid. That, is, the target pixel area secondary discrimination portion 12 may discriminate a position of the target pixel by using only pixels P22, P23, P24, P32, P34, P42, P43 and P44 immediately adjacent to the target pixel P33, as shown in FIG. 8B.

To this end, the target pixel area secondary discrimination portion 12 may compare pixel values between adjacent pixels P22, P23, P24, P32, P34, P42, P43 and P44 with one another, as shown in Mathematical Expression 7, to compute and provide an upper and lower pixel value difference dH_sub, a left and right pixel value difference dV_sub, a left diagonal pixel value difference dLD_sub, and a right diagonal pixel value difference dRD_sub. Here, it may be determined which of these pixel value differences has a minimum value.

[Mathematical Expression 7]

dH_sub=abs(P23−P43)
dV_sub=abs(P32−P34)
dRD_sub=abs(P43−P24)
dLD_sub=abs(P22−P44)
SORT(asecending)={dH_sub, dV_sub, dRD_sub, dLD_sub}

Subsequently, as shown in FIG. 8C, the upper and lower pixel value difference dH_sub, the left and right pixel value difference dV_sub, the right diagonal pixel value difference dRD_sub, and the left diagonal pixel value difference dLD_sub may be compared with the edge detection reference value Edge_Threshold to determine a position of the target pixel. That is, when all the pixel value differences dH_sub, dV_sub, dRD_sub and dLD_sub have a value smaller than the edge detection reference value Edge_Threshold, the target pixel may be defined as being positioned in the flat area. When the upper and lower pixel value difference dH_sub has a minimum value while having a value smaller than the edge detection reference value Edge_Threshold, a vertical edge area may be defined as a positional area of the target pixel. When the left and right pixel value difference dV_sub has a minimum value while having a value smaller than the edge detection reference value Edge_Threshold, a horizontal edge area may be defined as a positional area of the target pixel. When the right diagonal pixel value difference dRD_sub has a minimum value while having a value smaller than the edge detection reference value Edge_Threshold, a right diagonal direction edge area may be defined as a positional area of the target pixel. When the left diagonal pixel value difference dLD_sub has a minimum value while having a value smaller than the edge detection reference value Edge_Threshold, a left diagonal direction edge area may be defined as a positional area of the target pixel.

Hence, a discrimination result from the target pixel area secondary discrimination portion 12 may have an order of priority with regard to a discrimination result from the target pixel area primary discrimination portion 11, and accordingly, a position of the target pixel may be determined according to the discrimination result from the target pixel area secondary discrimination portion 12. In addition, the target pixel area primary discrimination portion 11 may be omitted or may be provided such that it may serve to perform a signal transfer, as necessary.

The defective pixel determination unit 20 may select different neighboring pixels according to a position of the target pixel to determine whether the target pixel is defective. When the target pixel is located in the flat area, it may be additionally determined whether a corresponding target pixel is a single defective pixel or a cluster of defective pixels.

That is, when the target pixel P33 is located in the flat area, the defective pixel determination unit 20 may select all the homogeneous pixels (P11, P13, P15, P31, P35, P51, P53, P55) and (P31, P35) as neighboring pixels. Furthermore, when the target pixel P33 is located on the horizontal edge area, the defective pixel determination unit 20 may select only homogeneous pixels P31 and P35 positioned on the left and right of the target pixel as neighboring pixels. When the target pixel P33 is located on the vertical edge area, only homogeneous pixels P13 and P53 located above and below of the target pixel may be selected as neighboring pixels. When one target pixel P33 is located on a right diagonal direction edge area, homogeneous pixels P15 and P51 located in the right diagonal direction may be selected as neighboring pixels, and when one target pixel P33 is located on a left diagonal direction edge area, homogeneous pixels P11 and P55 located in the left diagonal direction from the target pixel may be selected as neighboring pixels.

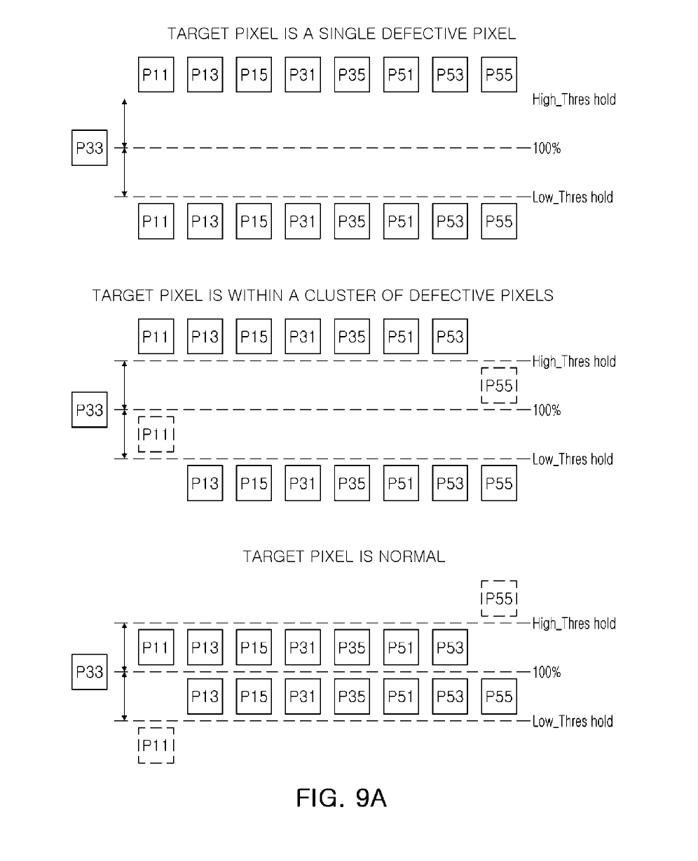

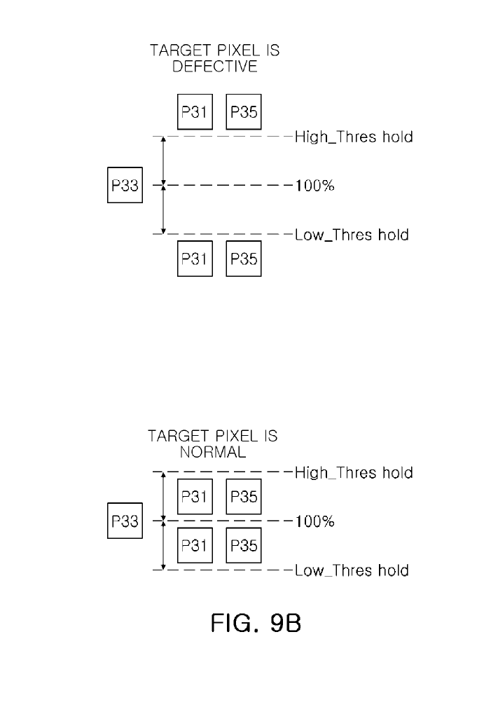

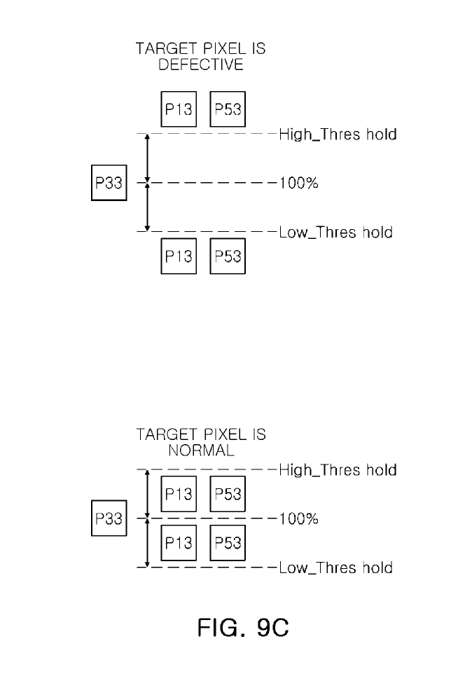

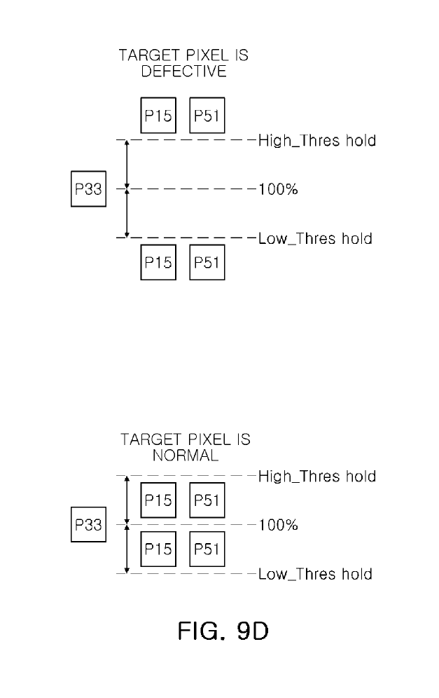

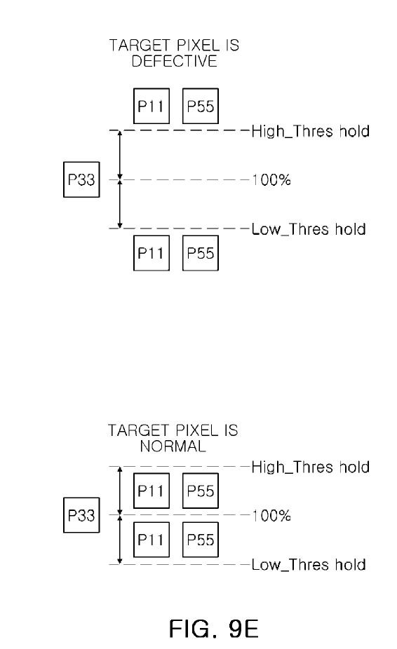

As shown in FIGS. 9A to 9E, a pixel value difference between neighboring pixels and a target pixel may be calculated and then compared to the defective pixel detection ranges, for example, High_Threshold(%)˜Low_Threshold(%), to determine whether the target pixel is defective.

In particular, when the target pixel is positioned in the flat area, the number of neighboring pixels having a pixel value difference deviating from the defective pixel detection ranges may be additionally determined as shown in FIG. 9A, to additionally verify whether or not the target pixel is a single defective pixel or a cluster of defective pixels. That is, it may be additionally verified as to whether there is another defective pixel in addition to the target pixel. For example, when all the pixel value differences deviate from the defective pixel detection ranges, the target pixel may be determined as a single defective pixel. When a pre-determined number or more, for example, seven or more, of pixel value differences deviate from the defective pixel detection ranges, the target pixel may be determined as being within a cluster of defective pixels. When a pre-determined number or more, for example, seven or more, of pixel value differences are included within the defective pixel detection ranges, the target pixel may be determined to be a normal pixel.

In the case of the defective pixel correction unit 30, different methods may be used to correct the target pixel taking into consideration a position of the target pixel and other defective pixels. In particular, when the target pixel is located in the flat area and is a single defective pixel, the target pixel may be corrected using all of pixel values of neighboring pixels. When the target pixel is within a cluster of defective pixels, the target pixel may be corrected using a portion of the neighboring pixels.

$$[ Mathematical Expression 8 ]$$

$$SORT = \{ P 11 , P 13 , P 15 , P 31 , P 35 , P 51 , P 53 , P 55 \}$$

$$\frac{( p 3 rd + p 4 th + p 5 th + p 6 th )}{4}$$

That is, when the target pixel is located in the flat area and is in a cluster of defective pixels, the defective pixel correction unit 30 may align the neighboring pixels P11, P13, P15, P31, P35, P51, P53 and

P55 in a pixel value sequence and correct the target pixel by using only p3rd, p4th, p5th and p6th neighboring pixels having pixel values in a middle range.

Furthermore, when the target pixel is located on the horizontal edge area or the vertical edge area, the target pixel may be corrected using the above-mentioned mathematical expressions 5 and 6. When the target pixel is located on the right diagonal direction edge area and the left diagonal direction edge area, the target pixel may be corrected using the following mathematical expressions and 10.

$$\begin{matrix}\frac{( P 15 + P 51 )}{2} & [ Mathematical Expression 9 ] \\ \frac{( P 11 + P 55 )}{2} & [ Mathematical Expression 10 ]\end{matrix}$$

That is, an apparatus for correcting a defective pixel according to an embodiment of the present invention may correct a target pixel in consideration of the number of defective pixels, as well as well as a position of the target pixel.

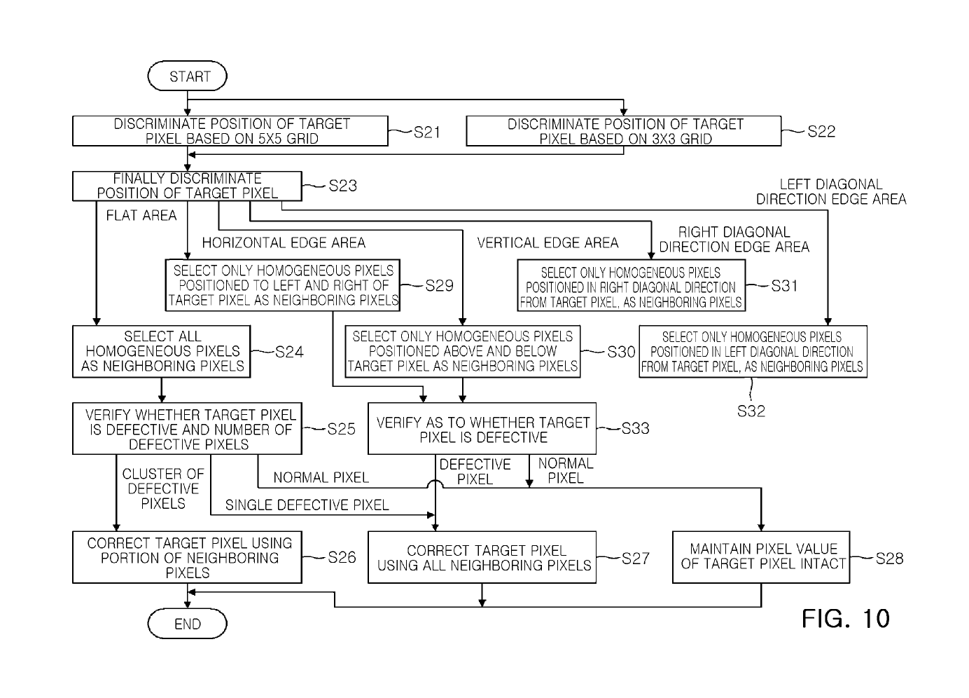

FIG. 10 is a flowchart showing a method of correcting a defective pixel according to an embodiment of the present invention, taking into account the number of defective pixels as well as a position of a target pixel.

First, a 5×5 grid image and a 3×3 grid image may be input at the same time, and a position of the target pixel P33 may be discriminated by using each of the 5×5 grid image and the 3×3 grid image in operation S21 and operation S22.

In consideration of results in operations S21 and S22, a position of the target pixel P33 may be discriminated in operation S23 into a flat area, a horizontal edge area, a vertical edge area, a right diagonal direction edge area, or a left diagonal direction edge area. In operation S23, the position of the target pixel P33 may be discriminated in order of priority on the position of the target pixel P33 that has been discriminated using the 3×3 grid image.

For example, when the target pixel P33 is determined to be positioned in the flat area, all homogeneous pixels P11, P13, P15, P31, P35, P51, P53 and P55 may be selected as neighboring pixels in operation S24, and it may be determined as to whether or not the target pixel is defective. In operation S25 the number of defective pixels may be determined by using all homogeneous pixels P11, P13, P15, P31, P35, P51, P53 and P55.

As a result of operation S25, when the target pixel P33 is within a cluster of defective pixels, the target pixel may be corrected using only a portion of neighboring pixels in operation S26, as shown in the mathematical expression 8. That is, the target pixel may be corrected using only pixels p3rd, p4th, p5th and p6th having pixel values in a middle range among the neighboring pixels P11, P13, P15, P31, P35, P51, P53 and P55.

As a result of operation S25, when the target pixel P33 is a single defective pixel, the target pixel may be corrected using pixel values of all of the neighboring pixels P11, P13, P15, P31, P35, P51, P53 and P55 in operation S27, as shown in the mathematical expression 4.

As a result of operation S25, when the target pixel P33 is a normal pixel, a pixel value of the target pixel may be maintained intact. That is, a correction operation is not performed in operation S28.

When the target pixel P33 is positioned on the horizontal edge area, only pixels P31 and P35 located on the left and right of the target pixel may be selected from the homogeneous pixels P11, P13, P15, P31, P35, P51, P53 and P55 in operation S29.

In the same manner as described above, when the target pixel P33 is located on the vertical edge area, only homogeneous pixels P13 and P53 positioned above and below the target pixel P33 may be selected as neighboring pixels in operation S30. When the target pixel P33 is located on the right diagonal direction edge area, only pixels P15 and P51 positioned in the right diagonal direction from the target pixel P33 may be selected as neighboring pixels in operation S31. When the target pixel P33 is located on the left diagonal direction edge area, only pixels P11 and P55 positioned in the left diagonal direction from the target pixel P33 may be selected as neighboring pixels in operation S32.

It may then be determined whether the target pixel is defective by using the neighboring pixels selected through operation S29, S30, S31 or S32 in operation S33, and then, when the target pixel is defective, the next operation is operation S27, and when the target pixel is normal, the next operation is operation S28.

In addition, according to an embodiment of the present invention, an edge detection reference value Edge_Threshold, defective pixel detection ranges, for example, High_Threshold(%)˜Low_Threshold(%), a determination threshold number to determine whether there is a single defective pixel or a cluster of defective pixels, and a distance for selecting homogeneous pixels may be values that need to be determined. While all these values may be pre-determined, it is also conceivable that these values be determined dynamically depending on the number of defective pixels that are detected and corrected.

As set forth above, in an apparatus and method for correcting a defective pixel according to an embodiment of the present invention, neighboring pixels may be selected in consideration of a position of a target pixel, whereby enhanced precise and reliable defective pixel detection and target pixel correction may be undertaken. According to an embodiment of the present invention, natural image characteristics can be obtained at all times, regardless of a position of the target pixel, and therefore, image distortion may be significantly reduced and production yield may increase.

In addition, in an apparatus and method for correcting a defective pixel according to an embodiment of the present invention, neighboring pixels may be selected in consideration of the number of defective pixels as well as a position of a target pixel, whereby precise and reliable defective pixel detection and target pixel correction may significantly increase.

While the present invention has been shown and described in connection with the embodiments in the embodiments, it will be apparent to those skilled in the art that modifications and variations can be made without departing from the spirit and scope of the invention as defined by the appended claims. For example, while FIG. 10 described a 5×5 grid and a 3×3 grid as being introduced in parallel, the invention need not be so limited. For example, the 5×5 grid may be introduced and a 3×3 grid may be derived from the 5×5 grid. The operations using the 5×5 grid and the 3×3 grid may then be in parallel or in series.

What is claimed:

1. An apparatus for correcting a defective pixel, the apparatus comprising:
a target pixel area discrimination unit configured to determine a position of a target pixel;
a defective pixel determination unit configured to select neighboring pixels in consideration of the position of the target pixel to determine whether the target pixel is defective; and
a defective pixel correction unit configured to correct the target pixel by using at least some of the neighboring pixels.

2. The apparatus of claim 1, wherein the neighboring pixels are homogeneous pixels with respect to the target pixel.

3. The apparatus of claim 2, wherein each of the neighboring pixels is separated from the target pixel by a single pixel vertically, horizontally, or diagonally.

4. The apparatus of claim 3, wherein the target pixel area discrimination unit is configured to determine whether the target pixel is in one of: a flat area, a vertical edge area, and a horizontal edge area.

5. The apparatus of claim 4, wherein the defective pixel determination unit is configured to use all neighboring pixels when the target pixel is determined to be in the flat area, uses only the neighboring pixels located on the left and right of the target pixel when the target pixel is determined to be in the horizontal edge area, and uses only the neighboring pixels located above and below the target pixel when the target pixel is determined to be in the vertical edge area.

6. The apparatus of claim 3, wherein the defective pixel discrimination unit is configured to determine whether the target pixel is defective by using pixel values of the neighboring pixels.

7. The apparatus of claim 3, wherein the defective pixel correction unit is configured to correct the target pixel to an average pixel value of the neighboring pixels when the target pixel is determined to be defective.

8. The apparatus of claim 3, wherein the target pixel area discrimination unit is configured to determine whether the target pixel is in one of a flat area, a vertical edge area, a horizontal edge area, a left diagonal direction edge area, and a right diagonal direction edge area.

9. The apparatus of claim 8, wherein the defective pixel determination unit is configured to use all the neighboring pixels when the target pixel is determined to be in the flat area, uses only the neighboring pixels located on the left and right of the target pixel when the target pixel is determined to be in the horizontal edge area, uses only the neighboring pixels located above and below the target pixel when the target pixel is determined to be in the vertical edge area, selects only the neighboring pixels located in a left diagonal direction from the target pixel when the target pixel is determined to be in the left diagonal direction edge area, and uses only the neighboring pixels located in a right diagonal direction from the target pixel when the target pixel is determined to be in the right diagonal direction edge area.

10. The apparatus of claim 8, wherein the defective pixel determination unit is configured to determine whether the target pixel is defective by analyzing the pixel values of the neighboring pixels.

11. The apparatus of claim 10, wherein the defective pixel determination unit is configured to additionally determine, when the target pixel is positioned in the flat area, whether the target pixel is a single defective pixel or is one of a plurality of defective pixels.

12. The apparatus of claim 11, wherein the defective pixel correction unit is configured to correct the target pixel, when the target pixel is determined to be one of a plurality of defective pixels, by sorting the neighboring pixels by pixel value, and using a subset of the sorted pixels that does not include at least the pixel with the largest pixel value and the pixel with the smallest pixel value.

13. The apparatus of claim 8, wherein the defective pixel correction unit is configured to correct the target pixel to an average pixel value of the neighboring pixels when only the target pixel is determined to be defective.

14. The apparatus of claim 1, further comprising a pixel output unit configured to clamp and output a pixel value of the corrected target pixel.

15. A method of correcting a defective pixel, the method comprising:
determining a position of a target pixel by using neighboring pixels of the target pixel, wherein each of the neighboring pixels is a homogeneous pixel with respect to the target pixel that is separated from the target pixel by a single pixel vertically, horizontally, or diagonally;
selecting a subset of the neighboring pixels in consideration of the position of the target pixel;
determining whether the target pixel is defective by using the subset of the neighboring pixels; and
correcting the target pixel using the subset of the neighboring pixels if the target pixel is determined to be defective.

16. The method of claim 15, wherein the selecting of the subset of the neighboring pixels includes:
selecting all neighboring pixels when the target pixel is determined to be in a flat area;
selecting only neighboring pixels located to the left and right of the target pixel when the target pixel is determined to be in a horizontal edge area; and
selecting only neighboring pixels located above and below the target pixel when the target pixel is determined to be in a vertical edge area.

17. A method of correcting a defective pixel, the method comprising:
determining a position of a target pixel by using neighboring pixels of the target pixel, wherein each of the neighboring pixels is separated from the target pixel by a single pixel vertically, horizontally, or diagonally;
determining whether the target pixel is a single defective pixel or one of a plurality of defective pixels; and
correcting the target pixel, when the target pixel is the single defective pixel, by using the neighboring pixels in a first manner, and when the target pixel is one the plurality of defective pixels is present, correcting the target pixel by using the neighboring pixels in a second manner.

18. The method of claim 17, wherein correcting the target pixel using the neighboring pixels in the first manner includes:
using all the neighboring pixels when the target pixel is determined to be in a flat area;
using only the neighboring pixels located on the left and right of the target pixel when the target pixel is determined to be in a horizontal edge area;
using only the neighboring pixels located above and below the target pixel when the target pixel is determined to be in a vertical edge area;
using only neighboring pixels located in a left diagonal direction from the target pixel when the target pixel is determined to be in the left diagonal direction edge area; and
using only neighboring pixels located in a right diagonal direction from the target pixel when the target pixel is determined to be in the right diagonal direction edge area.

19. The method of claim 17, wherein correcting the target pixel using the neighboring pixels in the second manner includes sorting the neighboring pixels by pixel value, and using a subset of the sorted pixels that does not include at least the pixel with the largest pixel value and the pixel with the smallest pixel value.

20. The method of claim 17, wherein the determining of whether the target pixel is a single defective pixel or one of a plurality the cluster of defective pixels includes:
determining whether the target pixel is defective; and
determining, when the target pixel is determined to be in the flat area, whether there is a plurality of defective pixels.
